(19) United States
(12) Patent Application Publication
(10) Pub. No.: US 2011/0280198 A1
(43) Pub. Date: Nov. 17, 2011

(54) MOBILE TERMINAL AND CONTROL METHOD THEREOF

(76) Inventors: Taeyong KIM, Seoul (KR); Mijin BAEK, Seoul (KR); Soojin KIM, Seoul (KR); Insu JUN, Seoul (KR)

(21) Appl. No.: 13/077,391

(22) Filed: Mar. 31, 2011

(30) Foreign Application Priority Data
May 11, 2010 (KR) 10-2010-0043920

(51) Int. Cl. H04W 72/04; H04W 88/02

(52) U.S. Cl. 370/329

(57) ABSTRACT

A mobile terminal includes a controller to establish a connection with a packet data network through a wireless communication unit. The controller selects one of a plurality of timer values that are respectively mapped to multiple applications for transmitting/receiving packet data through the connection based on a predetermined priority, operates a timer based on the selected timer value, and controls the connection based on the timer.

This application claims the benefit of and priority to Korean Patent Application No. 10-2010-0043920, filed on May 11, 2010, the contents of which is incorporated herein by reference.

### BACKGROUND

1. Field

One or more embodiments relate to communication terminals.

2. Background

Terminals can be classified into mobile terminals and stationary terminals. Mobile terminals can be classified into handheld terminals and vehicle mount terminals according to whether users can personally carry the terminals. There is a recent trend of providing an email service through mobile terminals, and thus improvement of structural parts and/or software parts of the mobile terminals is considered.

### BRIEF DESCRIPTION OF THE DRAWINGS

FIG. 1 shows one embodiment of a service network.

FIG. 2 shows one embodiment of a mobile terminal in the network.

FIG. 3 shows one method for controlling a mobile terminal.

FIG. 4 shows an operation performed by the mobile terminal to select an FD timer value as a new packet switched application is executed.

FIG. 5 shows an operation performed by the mobile terminal to select a fast dormancy (FD) timer value as a packet exchange application being executed is ended.

### DETAILED DESCRIPTION

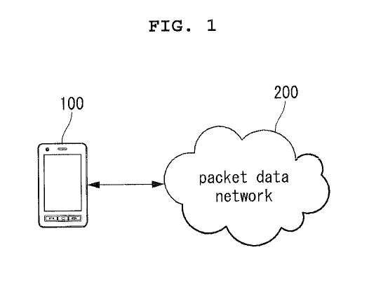

FIG. 1 shows a mobile terminal 100 linked to a packet data network 200 using a packet data protocol (PDP) context. The packet data network 200 may be a universal mobile telecommunication system (UMTS) network or a wireless code division multiple access (WCDMA) network. The packet data network 200 includes home location register (HLR), mobile service center (MSC), visitor location register (VLR), gateway MSC (GMSC), serving GPRS support node (SGSN), gateway GPRS support node (GGSN), etc. This is known in the art so that detailed explanation is omitted herein.

The PDP context includes information such as PDP type, PDP address, access point name (APN), quality of service (QoS), etc. required for the mobile terminal 100 to be linked to the packet data network 200 and provides a connection between the mobile terminal 100 and the packet data network 200 such that data can be transmitted and received between the mobile terminal 100 and the packet data network 200.

When the mobile terminal 100 is requested to execute an application of transmitting/receiving packet data to/from the packet data network 200, the mobile terminal 100 operates in relation to the packet data network 200 to activate the PDP context so as to set a connection with the packet data network 200. The mobile terminal 100 cancels the connection with the packet data network 200 by deactivating the PDP context. In the following description, the application of transmitting/receiving package data to/from the packet data network 200 is referred to as “packet switched application”.

The mobile terminal 100 activates a single PDP context to establish a single connection. The mobile terminal 100 has to activate multiple PDP contexts to establish multiple connections. Here, a connection established according to activation of the PDP is different from attachment to SGSN and means a connection with GGSN.

The mobile terminal 100 can support only a single PDP context or multiple PDP contexts according to the platform characteristic of the mobile terminal 100. Furthermore, the mobile terminal 100 can activate only a single PDP context or multiple PDP contexts according to a network environment.

The mobile terminal 100 sets a timer for executing a fast dormancy (FD) function for each connection establish through PDP context activation. Here, the FD function means a function of deactivating a PDP context to cancel a connection set using the PDP context without waiting for a control command of a network when there is no data transmitted/received through the connection for longer than a predetermined time.

Hereinafter, the timer for executing the FD function is referred to as “FD timer.” The mobile terminal 100 operates the FD timer for a time corresponding to an FD timer value and cancels the connection if there is no packet data transmitted/received between the mobile terminal 100 and the packet data network 200 until the FD timer is ended. When packet data is transmitted/received between the mobile terminal 100 and the packet data network 200 while the FD timer operates, the mobile terminal 100 maintains the connection and re-operates the FD timer.

Since a conventional mobile terminal can activate only a single PDP context, it is impossible to set the FD timer in consideration of all the packet transmitting/receiving patterns of multiple packet switched applications when the packet switched applications transmit/receive data through a single connection. That is, the conventional mobile terminal sets the FD timer in consideration of only a single packet switched application or operates the FD timer using a fixed timer value. Accordingly, the conventional mobile terminal maintains an unnecessary connection with the packet data network to cause unnecessary power consumption or cancels the connection too early and thus the traffic of a specific application becomes bad and QoS of the application cannot be satisfied.

Therefore, when multiple packet switched applications of the mobile terminal 100 transmit/receive data through a single connection, one or more embodiments described herein provide a control method of the mobile terminal 100 for satisfying QoS of each application while minimizing power consumption in consideration of the packet transmitting/receiving pattern of each application.

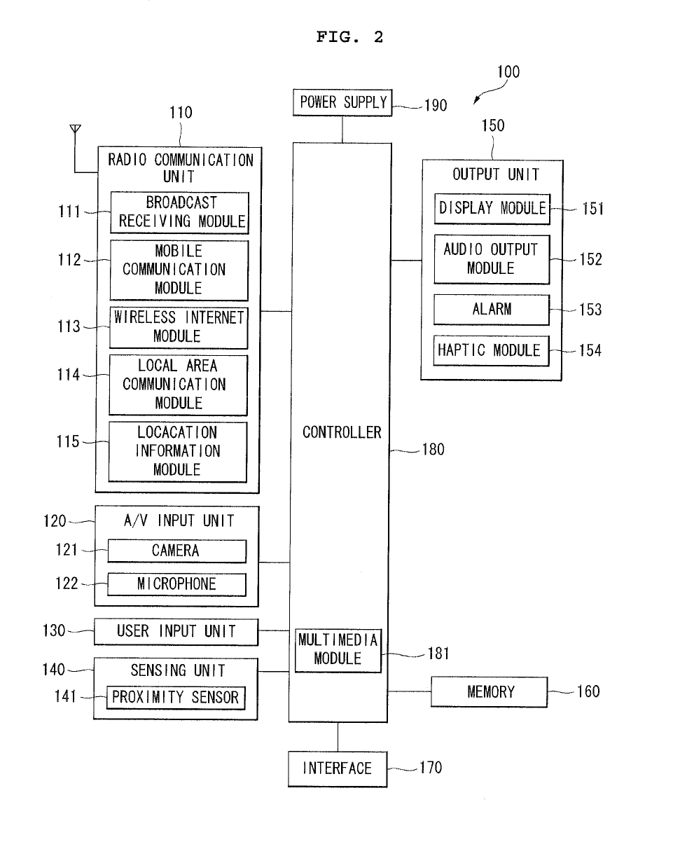

FIG. 2 shows one embodiment of a mobile terminal 100 which, for example, may operate in the network of FIG. 1. Other embodiments, configurations and arrangements may also be provided. As shown, a mobile terminal 100 may include a radio communication unit 110, an audio/video (A/V) input unit 120, a user input unit 130, a sensing unit 140, an output unit 150, a memory 160, an interface 170, a controller 180 and a power supply 190. The components shown in FIG. 2 are not essential parts and the number of components included in the mobile terminal can be varied.

The components of the mobile terminal will now be described.

The radio communication unit 110 can include at least one module that enables radio communication between the mobile terminal 100 and a radio communication system or between the mobile terminal 100 and a network in which the mobile terminal 100 is located. For example, the radio communication unit 110 can include a broadcasting receiving module 111, a mobile communication module 112, a wireless Internet module 113, a local area communication module 114 and a position information module 115.

The broadcasting receiving module 111 receives broadcasting signals and/or broadcasting related information from an external broadcasting management server through a broadcasting channel.

The broadcasting channel can include a satellite channel and a terrestrial channel. The broadcasting management server can be a server that generates and transmits broadcasting signals and/or broadcasting related information or a server that receives previously created broadcasting signals and/or broadcasting related information and transmits the broadcasting signals and/or broadcasting related information to a terminal. The broadcasting signals can include not only TV broadcasting signals, radio broadcasting signals and data broadcasting signals but also signals in the form of combination of a TV broadcasting signal and a radio broadcasting signal.

The broadcasting related information can be information on a broadcasting channel, a broadcasting program or a broadcasting service provider. The broadcasting related information can be provided even through a mobile communication network. In this case, the broadcasting related information can be received by the mobile communication module 112.

The broadcasting related information can exist in various forms. For example, the broadcasting related information can exist in the form of electronic program guide (EPG) of digital multimedia broadcasting (DMB) or in the form of electronic service guide (ESG) of digital video broadcast-handheld (DVB-H).

The broadcasting receiving module 111 receives broadcasting signals using various broadcasting systems. Particularly, the broadcasting receiving module 111 can receive digital broadcasting signals using digital broadcasting systems such as digital multimedia broadcasting-terrestrial (DMB-T), digital multimedia broadcasting-satellite (DMB-S), media forward link only (MediaFLO), DVB-H and integrated services digital broadcast-terrestrial (ISDB-T) systems. The broadcasting receiving module 111 can be constructed to be suited to broadcasting systems providing broadcasting signals other than the above-described digital broadcasting systems.

The broadcasting signals and/or broadcasting related information received through the broadcasting receiving module 111 can be stored in the memory 160.

The mobile communication module 112 transmits/receives a radio signal to/from at least one of a base station, an external terminal and a server on a mobile communication network. The radio signal can include a voice call signal, a video telephony call signal or data in various forms according to transmission and receiving of text/multimedia messages.

The wireless Internet module 113 means a module for wireless Internet access and can be included in the mobile terminal 100 or externally attached to the mobile terminal 100. Wireless LAN (WLAN) (Wi-Fi), wireless broadband (Wibro), world interoperability for microwave access (Wimax), high speed downlink packet access (HSDPA) and so on can be used as a wireless Internet technique.

The local area communication module 114 means a module for local area communication. Bluetooth, radio frequency identification (RFID), infrared data association (IrDA), ultra wideband (UWB) and ZigBee can be used as a local area communication technique.

The position information module 115 confirms or obtains the position of the mobile terminal. A global positioning system (GPS) module is a representative example of the position information module 115. According to the current technology, the GPS module 115 can calculate information on distances between one point (object) and at least three satellites and information on the time when the distance information is measured and apply trigonometry to the obtained distance information to obtain three-dimensional position information on the point (object) according to latitude, longitude and altitude at a predetermined time.

Furthermore, a method of calculating position and time information using three satellites and correcting the calculated position and time information using another satellite is also used. In addition, the GPS module 115 continuously calculates the current position in real time and calculates velocity information using the position information.

Referring to FIG. 2, the AN input unit 120 is used to input an audio signal or a video signal and can include a camera 121 and a microphone 122. The camera 121 processes image frames of still images or moving images obtained by an image sensor in a video telephony mode or a photographing mode. The processed image frames can be displayed on a display unit 151.

The image frames processed by the camera 121 can be stored in the memory 160 or transmitted to an external device through the radio communication unit 110. The mobile terminal 100 can include at least two cameras according to constitution of the terminal.

The microphone 122 receives an external audio signal in a call mode, a recording mode or a speed recognition mode and processes the received audio signal into electric audio data. The audio data can be converted into a form that can be transmitted to a mobile communication base station through the mobile communication module 112 and output in the call mode. The microphone 122 can employ various noise removal algorithms for removing noise generated when the external audio signal is received.

The user input unit 130 receives input data for controlling the operation of the terminal from a user. The user input unit 130 can include a keypad, a dome switch, a touch pad (constant voltage/capacitance), jog wheel, jog switch and so on.

The sensing unit 140 senses the current state of the mobile terminal 100, such as open/close state of the mobile terminal 100, the position of the mobile terminal 100, whether a user touches the mobile terminal 100, the direction of the mobile terminal 100 and acceleration/deceleration of the mobile terminal 100 and generates a sensing signal for controlling the operation of the mobile terminal 100. For example, the sensing unit 140 can sense whether a slide phone is opened or closed when the mobile terminal 100 is the slide phone. Furthermore, the sensing unit 140 can sense whether the power supply 190 supplies power and whether the interface 170 is connected to an external device. The sensing unit 140 can include a proximity sensor.

The output unit 150 generates visual, auditory or tactile output and can include the display unit 151, an audio output module 152, an alarm 153 and a haptic module 154.

The display unit 151 displays information processed by the mobile terminal 100. For example, the display unit 151 displays UI or graphic user interface (GUI) related to a telephone call when the mobile terminal is in the call mode. The display unit 151 displays a captured or/and received image, UI or GUI when the mobile terminal 100 is in the video telephony mode or the photographing mode.

The display unit 151 can include at least one of a liquid crystal display, a thin film transistor liquid crystal display, an organic light-emitting diode display, a flexible display and a three-dimensional display.

Some of these displays can be of a transparent type or a light transmission type. This can be referred to as a transparent display. The transparent display includes a transparent liquid crystal display. The rear structure of the display unit 151 can also be of the light transmission type. According to this structure, a user can see an object located behind the body of the mobile terminal 100 through an area of the body of the mobile terminal 100, which is occupied by the display unit 151.

The mobile terminal 100 can include at least two display units 151 according to constitution of the terminal. For example, the mobile terminal 100 can include a plurality of displays that are arranged on a single face at a predetermined distance or integrated. Otherwise, the plurality of displays can be arranged on different sides.

In the case where the display unit 151 and a sensor sensing touch (referred to as a touch sensor hereinafter) form a layered structure, which is referred to as a touch screen hereinafter, the display unit 151 can be used as an input device in addition to an output device. The touch sensor can be in the form of a touch film, a touch sheet and a touch pad, for example.

The touch sensor can be constructed such that it converts a variation in pressure applied to a specific portion of the display unit 151 or a variation in capacitance generated at a specific portion of the display unit 151 into an electric input signal. The touch sensor can be constructed such that it can sense pressure of touch as well as the position and area of touch.

When touch input is applied to the touch sensor, a signal corresponding to the touch input is transmitted to a touch controller. The touch controller processes the signal and transmits data corresponding to the processed signal to the controller 180. Accordingly, the controller 180 can detect a touched portion of the display 151.

Referring to FIG. 2, the proximity sensor 141 can be located in an internal region of the mobile terminal, surrounded by the touch screen, or near the touch screen. The proximity sensor senses an object approaching a predetermined sensing face or an object located near the proximity sensor using electromagnetic force or infrared rays without having mechanical contact. The proximity sensor has lifetime longer than that of a contact sensor and has wide application.

The proximity sensor includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, an infrared proximity sensor, etc.

A capacitive touch screen is constructed such that proximity of a pointer is detected through a variation in an electric field according to the proximity of the pointer. In this case, the touch screen (touch sensor) can be classified as a proximity sensor.

For convenience of explanation, an action of approaching the pointer to the touch screen while the pointer it not being in contact with the touch screen such that location of the pointer on the touch screen is recognized is referred to as “proximity touch” and an action of bring the pointer into contact with the touch screen is referred to as “contact touch” in the following description. A proximity touch point of the pointer on the touch screen means a point of the touch screen to which the pointer corresponds perpendicularly to the touch screen when the pointer proximity-touches the touch screen.

The proximity sensor senses proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can be displayed on the touch screen.

The audio output module 152 can output audio data received from the radio communication unit 110 or stored in the memory 160 in a call signal receiving mode, a telephone call mode or a recording mode, a speech recognition mode and a broadcasting receiving mode. The audio output module 152 outputs audio signals related to functions (for example, a call signal incoming tone, a message incoming tone, etc.) performed in the mobile terminal 100. The audio output module 152 can include a receiver, a speaker, a buzzer, etc.

The alarm 153 outputs a signal for indicating generation of an event of the mobile terminal 100. Examples of events generated in the mobile terminal include receiving of a call signal, receiving of a message, input of a key signal, input of touch, etc. The alarm 153 can output signals in forms different from video signals or audio signals, for example, a signal for indicating generation of an event through vibration. The video signals or the audio signals can be also output through the display unit 151 or the audio output module 152.

The haptic module 154 generates various haptic effects that the user can feel. A representative example of the haptic effects is vibration. The intensity and pattern of vibration generated by the haptic module 154 can be controlled. For example, different vibrations can be combined and output or sequentially output.

The haptic module 154 can generate a variety of haptic effects including an effect of stimulus according to arrangement of pins vertically moving for a contact skin face, an effect of stimulus according to jet force or sucking force of air through a jet hole or a sucking hole, an effect of stimulus rubbing the skin, an effect of stimulus according to contact of an electrode, an effect of stimulus using electrostatic force and an effect according to reproduction of cold and warmth using an element capable of absorbing or radiating heat in addition to vibrations.

The haptic module 154 can not only transmit haptic effects through direct contact but also allow the user to feel haptic effects through kinesthetic sense of his fingers or arms. The mobile terminal 100 can include at least two haptic modules 154 according to constitution of the mobile terminal.

The memory 160 can store a program for the operation of the controller 180 and temporarily store input/output data (for example, phone book, messages, still images, moving images, etc.). The memory 160 can store data about vibrations and sounds in various patterns, which are output from when a touch input is applied to the touch screen.

The memory 160 can include at least one of a flash memory, a hard disk type memory, a multimedia card micro type memory, a card type memory (for example, SD or XD memory), a random access memory (RAM), a static RAM (SRAM), a read-only memory (ROM), an electrically erasable programmable ROM (EEPROM), a programmable ROM (PROM) magnetic memory, a magnetic disk and an optical disk. The mobile terminal 100 can operate in relation to a web storage performing the storing function of the memory 160 on the Internet.

The interface 170 serves as a path to all external devices connected to the mobile terminal 100. The interface 170 receives data from the external devices or power and transmits the data or power to the internal components of the mobile terminal 100 or transmits data of the mobile terminal 100 to the external devices. The interface 170 can include a wired/wireless headset port, an external charger port, a wired/wireless data port, a memory card port, a port for connecting a device having a user identification module, an audio I/O port, a video I/O port, an earphone port, etc., for example.

An identification module is a chip that stores information for authenticating the authority to use the mobile terminal 100 and can include a user identify module (UIM), a subscriber identify module (SIM) and a universal subscriber identify module (USIM). A device (referred to as an identification device hereinafter) including the identification module can be manufactured in the form of a smart card. Accordingly, the identification device can be connected to the mobile terminal 100 through a port.

The interface 170 can serve as a path through which power from an external cradle is provided to the mobile terminal 100 when the mobile terminal 100 is connected to the external cradle or a path through which various command signals inputted by the user through the cradle to the mobile terminal 100. The various command signals or power input from the cradle can be used as a signal for confirming whether the mobile terminal 100 is correctly set in the cradle.

The controller 180 controls the overall operation of the mobile terminal. For example, the controller 180 performs control and processing for voice communication, data communication and video telephony. The controller 180 can include a multimedia module 181 for playing multimedia. The multimedia module 181 can be included in the controller 180 or separated from the controller 180.

The controller 180 can perform a pattern recognition process capable of recognizing handwriting input or picture-drawing input applied to the touch screen as characters or images.

The power supply 190 receives external power and internal power and provides power required for the operations of the components of the mobile terminal under the control of the controller 180.

Various embodiments can be implemented in a computer or similar device readable recording medium using software, hardware or a combination thereof, for example. In a hardware implementation, one or more embodiments can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units for executing functions. In some cases, the embodiments can be implemented by the controller 180.

In a software implementation, embodiments such as procedures or functions can be implemented with a separate software module executing at least one function or operation. Software codes can be implemented according to a software application written in an appropriate software language. Furthermore, the software codes can be stored in the memory 160 and executed by the controller 180. Various Embodiments described herein can be implemented in mobile terminal 100 explained with reference to FIGS. 1 and 2.

Embodiments of a control method to be performed by the mobile terminal 100 and various operations to be performed in or in association with the mobile terminal 100 for implementing the control method will now be explained. Particularly, a control method of the mobile terminal 100 capable of supporting only a single PDP context due to network characteristic or plat characteristic of the mobile terminal will be described.

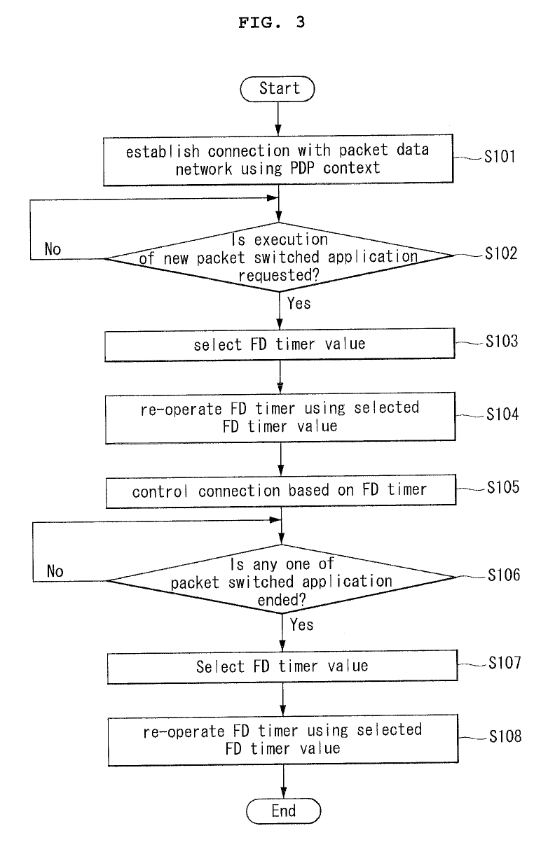

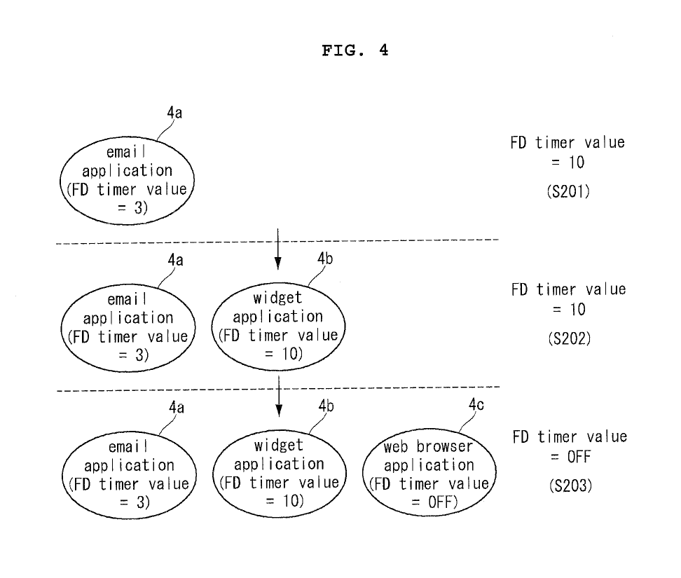

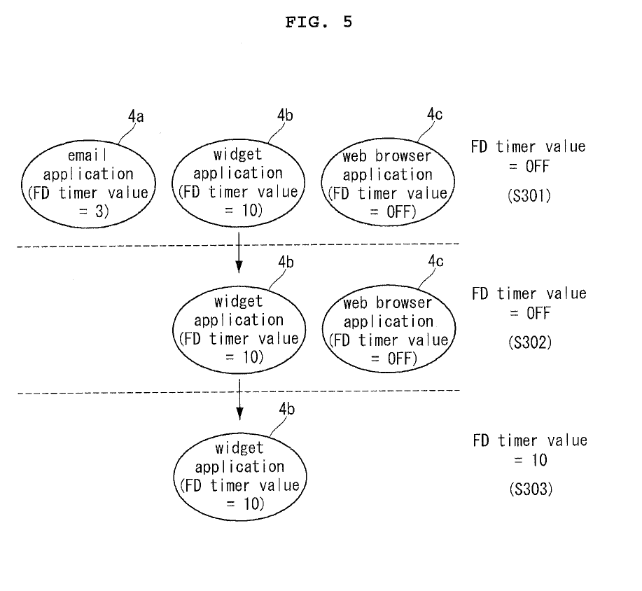

FIG. 3 shows steps included in one embodiment of a control method of the mobile terminal 100, and FIGS. 4 and 5 are views for explaining the control method of the mobile terminal 100. Referring to FIGS. 1, 2 and 3, the controller 180 establishes a connection with the packet data network 200 using a PDP context in operation S101. The controller 180 executes at least one packet switched application through the connection.

When the controller 180 is requested to execute a new packet switched application that transmits/receives packet data through the connection in operation S102, the controller 180 executes the requested packet switched application. In addition, the controller 180 selects one of fast dormancy (FD) timer values of multiple packet switched applications that transmit/receive packet data through the connection in operation S103. The controller 180 operates an FD timer corresponding to the connection by using the selected FD timer value in operation S104. The controller 180 controls the connection based on the FD timer in operation S105.

When one of the packet switched applications that transmit/receive packet data through the connection is ended in operation S106, the controller 180 selects one of the FD timer values mapped to other packet switched applications being executed in operation S107. Then, the controller 180 re-operates the FD timer using the selected FD timer value in operation S108.

In the operations S103 and S107, the controller 180 selects the FD timer values based on a predetermined priority. For example, the controller 180 selects an FD timer value corresponding to FD timer OFF from the FD timer values mapped to the packet switched applications first, and then selects a larger FD timer value preferentially. That is, if the FD timer values mapped to the packet switched applications include the FD timer value corresponding to FD timer OFF, the controller 180 selects the FD timer value corresponding to FD timer OFF to deactivate the FD timer. If the FD timer values mapped to the packet switched applications do not include the FD timer value corresponding to FD timer OFF, the controller 180 selects the largest FD timer values from the FD timer values mapped to the packet switched applications and operates the FD timer using the largest FD timer value.

In the current embodiment, the FD timer values mapped to the packet switched applications that transmit/receive packet data to/from the packet data network 200 may be previously defined during the packet switched applications are generated or set by the mobile terminal 100.

For example, the mobile terminal 100 can set the FD timer value of a packet switched application based on a packet transmitting/receiving pattern of the packet switched application, which includes a time when packet data transmitted from the packet switched application arrives at the packet data network 200, or a time when the packet switched application re-transmits packet data after the connection with the packet data network 200 is cancelled, etc.

In this case, the controller 180 may set a smaller FD timer value for an application that periodically transmits/receives short packet data to/from the packet data network 200, such as a push email application, than FD timer values of other applications. This is because the packet data receiving interval of the application may be very short.

Furthermore, the controller may set a larger FD timer value for an application transmitting/receiving packet data according to a user's operation, such as a web browser application, than FD timer values of other applications or deactivate the FD timer for the application. This is because the packet data transmitting/receiving interval related to the application is long. In addition, the controller 180 may group applications having similar packet transmitting/receiving patterns as a group and map an FD timer value, most suitable for the corresponding packet transmitting/receiving patterns of each group, to each group.

The mobile terminal 100 may set the FD timer value of an application based on the download route of the application. In this case, the controller 180 may discriminate an application downloaded through the Internet from an application previously downloaded to the mobile terminal 100 in an initial operation of the mobile terminal 100 and map different FD timer values to the applications.

FIG. 4 shows an exemplary operation of the mobile terminal 100 to select an FD timer value as a new packet switched application is executed. Referring to FIG. 4, the mobile terminal 100 sets the operating time of the FD timer to 3 when an email application 4a having an FD timer value of 3 is executed in operation S201.

When a widget application 4b having an FD timer value of 10 is executed, the mobile terminal 100 selects a larger one of the FD timer values of the email application 4a and the widget application 4b, that is, 10, based on a predetermined priority and operates the FD timer using the selected FD timer value in operation S202. That is, the operating time of the FD timer is set to 10.

When a web browser application 4c having an FD timer value OFF is executed, the mobile terminal 100 selects the FD timer value OFF from the FD timer values mapped to the email application 4a, the widget application 4b and the web browser application 4c based on the predetermined priority. Accordingly, the FD timer is deactivated in operation S203.

FIG. 5 shows an exemplary operation of the mobile terminal 100 to select an FD timer value as a packet switched application being executed is ended. Referring to FIG. 5, when the email application 4a having the FD timer value of 3, the widget application 4b having the FD timer value of 10, and the web browser application 4c having the FD timer value OFF are executed, the mobile terminal 100 selects the FD timer value OFF based on the predetermined priority. Accordingly, the FD timer is deactivated in operation S301.

When the email application 4a is ended, the mobile terminal 100 selects the FD time value OFF from the FD timer values of the widget application 4b and the web browser application 4c being executed based on the predetermined priority and deactivates the FD timer in operation S302.

According to at least one of the above-described embodiments, the mobile terminal 100 can drive the FD timer most suitable for multiple packet switched applications even when the mobile terminal 100 supports only a single PDP context due to the network characteristic or the platform characteristic of the mobile terminal 100. That is, it is possible to satisfy QoS of every packet switched application while minimizing power consumption required to maintain an unnecessary connection with the packet data network 100.

The above-described control method of the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

One or more embodiments described herein may therefore provide a mobile terminal and a control method thereof for minimizing power consumption according to email reception. As used herein, suffixes “module” and “unit” are given to components of the mobile terminal in consideration of only facilitation of description and do not have meanings or functions discriminated from each other.

Moreover, a mobile terminal as described herein can include a cellular phone, a smart phone, a laptop computer, a digital broadcasting terminal, personal digital assistants (PDA), a portable multimedia player (PMP), a navigation system and so on. However, those skilled in the art will easily understand that configurations according to embodiments of the present invention can also be applied to stationary terminals such as digital TV and desktop computers except a case where the configurations can be applied to only mobile terminals.

In accordance with one embodiment, a mobile terminal comprises a wireless communication unit and a controller to establish a connection with a packet data network through the wireless communication unit, select one of a plurality of timer values that are respectively mapped to multiple applications for transmitting/receiving packet data through the connection based on a predetermined priority, operate a timer based on the selected timer value, and control the connection based on the timer.

The controller may maintain the connection while the timer operates and cancels the connection when the timer ends, and may cancel the connection by deactivating a packet data protocol (PDP) context corresponding to the connection. Also, the mobile terminal may support only a single PDP context due to a network environment or platform characteristic of the mobile terminal. The timer may be a fast dormancy (FD) timer of a PDP context corresponding to the connection.

In addition, the controller may preferentially select the timer value to correspond to timer OFF from the plurality of mapped timer values. Also, the controller may select the time value to correspond to a largest timer value from the plurality of mapped timer values when the plurality of mapped timer values do not include the timer value corresponding to timer OFF.

In addition, the controller may map a timer value, calculated based on a packet transmitting/receiving pattern of at least one application that transmits/receives packet data to/from the packet data network, to the at least one application.

In addition, the controller may group applications that transmit/receive packet data to/from the packet data network into at least one group based on packet transmitting/receiving patterns of the applications and maps a same timer value to the at least one group. A packet transmitting/receiving pattern of the at least one application may be based on at least one of a time when packet data transmitted from the application arrives at the packet data network or a packet data receiving interval of the application.

In accordance with another embodiment, a control method of a mobile terminal comprises establishing a connection with a packet data network using a PDP context; simultaneously executing multiple applications that transmit/receive packet data through the connection; selecting one of a plurality of timer values respectively mapped to the multiple applications based on a predetermined priority; operating a timer using the selected timer value; and controlling the connection based on the timer.

The connection may be controlled by maintaining the connection while the timer operates; and canceling the connection when the timer is ended. Also, the mobile terminal may support only a single PDP context due to a network environment or platform characteristic of the mobile terminal.

The timer value may be selected by selecting the timer value to correspond to timer OFF from the plurality of mapped timer values when the plurality of mapped timer values includes the timer value corresponding to timer OFF; and selecting the time value to correspond to a largest timer value from the plurality of mapped timer values when the mapped timer values do not include the timer value corresponding to timer OFF. The timer is a fast dormancy (FD) timer of the PDP context.

In accordance with another embodiment, a computer-readable medium storing a program for controlling a mobile terminal, the program comprising: a first code section to establish a connection with a packet data network using a PDP context; a second code section to simultaneously execute multiple applications that transmit/receive packet data through the connection; a third code section to select one of a plurality of timer values respectively mapped to the multiple applications based on a predetermined priority; a fourth code section to operate a timer based on the selected timer value; and a fifth code section to control the connection based on the timer. The code sections may be separate code sections or two or more of the code sections may overlap.

The third code section may select the timer value to correspond to timer OFF from the plurality of mapped timer values when the plurality of mapped timer values includes the timer value corresponding to timer OFF; and select the time value to correspond to a largest timer value from the plurality of mapped timer values when the mapped timer values do not include the timer value corresponding to timer OFF.

The fifth code section may maintain the connection while the timer operates; and cancel the connection when the timer is ended. Also, the mobile terminal may support only a single PDP context due to a network environment or platform characteristic of the mobile terminal. The timer may ye a fast dormancy (FD) timer of the PDP context.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. The features of one embodiment may be combined with features of remaining embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a wireless communication unit; and
a controller configured to establish a connection with a packet data network through the wireless communication unit, select one of a plurality of timer values respectively mapped to multiple applications, which transmit/receive packet data through the connection, based on a predetermined priority, operate a timer based on the selected timer value, and control the connection based on the timer.

2. The mobile terminal of claim 1, wherein the controller maintains the connection while the timer operates and cancels the connection when the timer is ended.

3. The mobile terminal of claim 2, wherein the controller cancels the connection by deactivating a packet data protocol (PDP) context corresponding to the connection.

4. The mobile terminal of claim 3, wherein the mobile terminal supports only a single PDP context due to a network environment or platform characteristic of the mobile terminal.

5. The mobile terminal of claim 1, wherein the timer is a fast dormancy (FD) timer of a PDP context corresponding to the connection.

6. The mobile terminal of claim 1, wherein the controller preferentially selects the timer value to correspond to timer OFF from the plurality of timer values.

7. The mobile terminal of claim 6, wherein the controller selects the time value to correspond to a largest timer value from the plurality of timer values when the plurality of mapped timer values do not include the timer value corresponding to timer OFF.

8. The mobile terminal of claim 1, wherein the controller maps a timer value, calculated based on a packet transmitting/receiving pattern of at least one application that transmits/receives packet data to/from the packet data network, to the at least one application.

9. The mobile terminal of claim 1, wherein the controller groups applications, that transmit/receive packet data to/from the packet data network, into at least one group based on packet transmitting/receiving patterns of the applications and maps a same timer value to at applications grouped as same group.

10. The mobile terminal of claim 8, wherein a packet transmitting/receiving pattern of the application is based on a time when packet data transmitted from the application arrives at the packet data network or a packet data receiving interval of the application.

11. A control method of a mobile terminal, comprising:
establishing a connection with a packet data network using a PDP context;
executing multiple applications that transmit/receive packet data through the connection;
selecting one of a plurality of timer values respectively mapped to the multiple applications based on a predetermined priority;
operating a timer using the selected timer value; and
controlling the connection based on the timer.

12. The control method of claim 11, wherein said controlling comprises:
maintaining the connection while the timer operates; and
canceling the connection when the timer is ended.

13. The control method of claim 11, wherein the mobile terminal supports only a single PDP context due to a network environment or platform characteristic of the mobile terminal.

14. The control method of claim 11, wherein said selecting comprises:
selecting the timer value to correspond to timer OFF from the plurality of mapped timer values when the plurality of timer values includes the timer value corresponding to timer OFF; and
selecting the time value to correspond to a largest timer value from the plurality of timer values when the mapped timer values do not include the timer value corresponding to timer OFF.

15. The control method of claim 11, wherein the timer is a fast dormancy (FD) timer of the PDP context.

16. A computer-readable medium storing a program for controlling a mobile terminal, the program comprising:
a first code section to establish a connection with a packet data network using a PDP context;
a second code section to execute multiple applications that transmit/receive packet data through the connection;
a third code section to select one of a plurality of timer values respectively mapped to the multiple applications based on a predetermined priority;
a fourth code section to operate a timer based on the selected timer value; and
a fifth code section to control the connection based on the timer.

17. The medium of claim 16, wherein the fifth code section is to:
maintain the connection while the timer operates; and
cancel the connection when the timer is ended.

18. The medium of claim 16, wherein the mobile terminal supports only a single PDP context due to a network environment or platform characteristic of the mobile terminal.

19. The medium of claim 16, wherein the third code section is to:
select the timer value to correspond to timer OFF from the plurality of mapped timer values when the plurality of timer values includes the timer value corresponding to timer OFF; and
select the time value to correspond to a largest timer value from the plurality of mapped timer values when the timer values do not include the timer value corresponding to timer OFF.
